(19) United States
(12) Patent Application Publication
(10) Pub. No.: US 2023/0180906 A1
(43) Pub. Date: Jun. 15, 2023

(54) HAIRDRYER

(71) Applicant: LG ELECTRONICS INC., Seoul (KR)

(72) Inventors: Giyeob YANG, Seoul (KR); Seongho CHO, Seoul (KR)

(73) Assignee: LG ELECTRONICS INC., Seoul (KR)

(21) Appl. No.: 17/924,485

(22) PCT Filed: Mar. 11, 2021
(86) PCT No.: PCT/KR2021/003022

§ 371 Date: Nov. 10, 2022

(30) Foreign Application Priority Data
May 11, 2020 (KR) 10-2020-0055992

(51) Int. Cl. A45D 20/12; F04D 29/38; F04D 29/54

(52) U.S. Cl. CPC A45D 20/12; F04D 29/38; F04D 29/54

(57) ABSTRACT

The present disclosure relates to a hairdryer and, more specifically, to a hairdryer wherein a ratio between dimensions of fan unit components is appropriately changed to stabilize the flow of air introduced into a fan unit and suppress occurrence of turbulence so that internal flow efficiency can be increased and the noise can be decreased.

### TECHNICAL FIELD

The present disclosure relates to a hairdryer, and more particularly to a hairdryer configured such that air introduced through an inlet is discharged toward an outlet and hair is dried or tidied using the discharged air.

### BACKGROUND ART

A hairdryer is used to dry wet hair or to style hair so as to have a specific shape. In addition, the hairdryer is also used to tidy air.

When hair is dried using the hairdryer, it is required to form air flow at a high speed in order to generate wind.

Consequently, a motor configured to rotate at a high speed and a blowing fan coupled thereto are necessary. Wind may be generated by air flow generated by the blowing fan, and hair may be dried or styled using the generated wind.

During forcible generation of air flow, however, an air flow path is suddenly changed, whereby turbulence or vortex may be generated, and flow may be unstable, whereby air flow efficiency may be reduced. In addition, noise is generated by such unstable turbulence or vortex.

Noise of the hairdryer is mainly generated by two factors. First, air rapidly moved by the blowing fan collides with an inner wall of a main body of the hairdryer and parts of the hairdryer, whereby noise is generated. Second, physical and electromagnetic vibration generated when a rotor of the motor is rotated at a high speed is transmitted to the main body of the hairdryer, whereby noise is generated.

When describing the process in which noise is generated as the first reason in detail, the flow of air formed by the motor collides with the inner structure of the motor, whereby turbulence is formed, or unnecessary noise is generated due to friction with the inner structure.

In addition, as mentioned above, turbulence is formed when noise is generated. In most cases, such formation of turbulence is not expected during design of the hairdryer, and it is preferable to inhibit such generation of turbulence even though formation of turbulence is expected. If turbulence is formed, efficiency of the motor is reduced, and power is unnecessarily consumed.

Generation of noise due to the first reason may be inhibited by appropriately changing the structure or disposition of the main body and the parts of the hairdryer.

Consequently, there is a need to provide a method of performing control such that air gently flows in a driving unit of the hairdryer without formation of turbulence, thereby preventing generation of unnecessary noise and solving a power consumption problem.

In connection therewith, Korean Registered Patent Publication No. 10-1407404 discloses a hairdryer configured such that a suction grill, which is located at a part through which air is introduced, having a smaller size than a conventional suction grill is inserted into the hairdryer, whereby it is possible to reduce noise generated when the hairdryer is operated.

In addition, Korean Patent Application Publication No. 10-2016-0096330 discloses a hairdryer configured to solve a problem with noise generated as the result of motor vibration being amplified into sound. In order to solve the noise problem, a transmission capable of increasing rotational frequency of the motor and transmitting rotation of the motor to a blowing fan is used. Although the motor is driven at a relatively low rotational speed, the blowing fan connected to the transmission may be rotated at a high speed, whereby it is possible to solve the noise problem without reduction of wind speed.

Since the prior inventions solving the noise problem do not remove the flow of air that generates noise using structural disposition or shape, it is not possible to fundamentally solve the noise problem. In addition, additional construction is necessary, whereby problems of space occupation and cost addition occur.

Consequently, there is a need to develop a hairdryer capable of stabilizing the flow of air introduced thereinto by changing a structural shape without addition of construction, reducing noise due to air flow, and preventing reduction in motor efficiency.

### DISCLOSURE

### Technical Task

One task of the present disclosure is to minimize loss generated at a blade, thereby improving efficiency of a hairdryer.

Another task of the present disclosure is to appropriately change the structure and shape of a blade of an impeller, thereby providing a hairdryer having high efficiency.

Another task of the present disclosure is to appropriately change the structure and shape of a blade of a vane, thereby providing a hairdryer having high efficiency.

Another task of the present disclosure is to appropriately adjust the diameter of a hub and the chord length of the blade of the impeller or the vane, thereby providing a hairdryer having high efficiency.

Another task of the present disclosure is to minimize flow loss of air introduced into an air flow unit, thereby improving fan motor flow channel efficiency.

Another task of the present disclosure is to stabilize the flow or air introduced into the fan motor without addition of a component, thereby providing a hairdryer capable of efficiently using an inner space thereof.

A further task of the present disclosure is to change the structure and shape of inner components of the air flow unit, thereby providing a hairdryer capable of minimizing loss generated at a blade and reducing generation of noise.

### Technical Solutions

In order to solve the tasks of the present disclosure, the diameter of an impeller and the number and length of blades may be adjusted, whereby blade loss may be reduced.

In order to solve the tasks of the present disclosure, the diameter of a guide unit and the number and length of blades may be adjusted, whereby blade loss may be reduced.

The value obtained by dividing C (chord length) by S (space) may be appropriately adjusted to minimize blade loss. Here, C indicates the chord length of the blade, and S indicates the value obtained by dividing the circumferential length by the number of blades. That is, the chord length of the blade may be set depending on the number of blades.

In addition, the diameter of the impeller may be set based on the diameter of a fan motor, and the diameter of an impeller hub may be set based on the diameter of the motor.

Efficiency of the impeller is highest when C/S is 1.4 to 1.5, and efficiency of the guide unit is highest when C/S is 1.5 to 2.0.

In order to solve the tasks, the present disclosure provides a hairdryer including a main body provided in one side thereof with an outlet configured to allow air to be discharged therethrough, a handle extending from one side of the main body, the handle including an inlet communicating with the outlet, the inlet being configured to allow external air to be introduced therethrough, a heater provided in the main body, the heater being configured to heat the air introduced through the inlet, and an air flow unit disposed in one of the main body and the handle, the air flow unit being configured to move the air introduced through the inlet toward the outlet, wherein the air flow unit includes a case defining an external shape thereof, the case having a suction portion provided at one side thereof and a discharge portion provided at the other side thereof, a driving unit including a stator fixed in the case, the stator being configured to generate a rotating magnetic field, and a rotor received in the stator so as to be rotated by the rotating magnetic field, a rotary shaft extending from the rotor toward the suction portion or the discharge portion or coupled to the rotor, and an impeller coupled to one end of the rotary shaft adjacent to the suction portion, the impeller being configured to suction air in the atmosphere while being rotated together with the rotary shaft, the impeller includes a hub coupled to the rotary shaft and at least one blade protruding from the hub toward an inner circumferential surface of the case, the blade being configured to generate air flow as the rotary shaft is rotated, the blade includes a first fixing portion disposed in contact with the hub, a first free portion disposed adjacent to the case, the first free portion being configured to form a free end, and a first body portion configured to connect the first fixing portion and the first free portion to each other, and a first chord length, which is the straight distance of the first fixing portion between one end and the other end of the rotary shaft in an axial direction, is greater than 1.4 times a first circumferential length, which is the value obtained by dividing the circumferential length of the hub by the number of the blades, and is less than 1.5 times the first circumferential length.

A second chord length, which is the straight distance of the first free portion between the one end and the other end of the rotary shaft in the axial direction, may be greater than 1.4 times a second circumferential length, which is the value obtained by dividing the circumferential length of a circle having a diameter equal to the diameter of the impeller by the number of the blades, and may be less than 1.5 times the second circumferential length.

The hairdryer may further include a guide unit coupled to an outer circumferential surface of the stator, the guide unit being configured to guide air suctioned by the impeller toward the discharge portion.

The guide unit may include a guide hub coupled to the stator and a plurality of guide blades protruding from the guide hub toward the inner circumferential surface of the case, the guide blade being configured to guide the air suctioned by the impeller to the discharge portion.

The number of the blades may be greater than or equal to the number of the guide blades.

The guide blade may include a second fixing portion disposed in contact with the guide hub, a second free portion disposed adjacent to the case, the second free portion being configured to form a free end, and a second body portion configured to connect the second fixing portion and the second free portion to each other, and a third chord length, which is the straight distance of the second fixing portion between the one end and the other end of the rotary shaft in the axial direction, may be greater than 1.5 times a third circumferential length, which is the value obtained by dividing the circumferential length of the guide hub by the number of the guide blades, and may be less than 2 times the third circumferential length.

The third chord length may be greater than or equal to the first chord length.

The third circumferential length may be greater than or equal to the first circumferential length.

A fourth chord length, which is the straight distance of the second free portion between the one end and the other end of the rotary shaft in the axial direction, may be greater than 1.5 times a fourth circumferential length, which is the value obtained by dividing the circumferential length of a circle having a diameter equal to the diameter of the guide unit by the number of the guide blades, and may be less than 2 times the fourth circumferential length.

The diameter of the guide hub may be greater than or equal to the diameter of the hub.

The blade may be inclined relative to the axial direction of the rotary shaft, and the guide blade may be inclined in a direction opposite the direction in which the blade is inclined relative to the axial direction of the rotary shaft.

The hub may include a hub body from which the blade protrudes and a hub cap extending from one surface of the hub body adjacent to the suction portion toward the suction portion, and the hub cap may have a sectional area decreased in an extension direction thereof.

The hub cap may include a first surface configured to form a free end and a second surface configured to connect the first surface and the hub body to each other, and the diameter of the first surface may be less than the diameter of the hub body.

The second surface may be formed convex toward the suction portion.

The first surface may be disposed in the case.

The guide hub may include a guide hub body from which the guide blade protrudes and a guide hub cap extending from one surface of the guide hub body adjacent to the impeller toward the impeller, and the guide hub cap may have a sectional area decreased in an extension direction thereof.

The guide hub cap may include a third surface configured to form a free end and a fourth surface configured to connect the third surface and the guide hub body to each other, and the diameter of the third surface may be less than the diameter of the guide hub body.

The diameter of the third surface may be greater than or equal to the diameter of the hub.

The diameter of the guide hub may be greater than or equal to the diameter of the hub.

The air flow unit may be provided in the handle and may be located between the inlet and the main body.

### Advantageous Effects

The present disclosure has an effect of providing a hairdryer capable of reducing noise generated by air flow using correlation in number of blades and chord length between an impeller and a vane.

The present disclosure has an effect of providing a hairdryer capable of achieving flow stabilization and reducing flow loss by changing the structure and shape of each of existing components without addition of another component.

The present disclosure has an effect of providing a hairdryer capable of reducing flow loss of an air flow unit, thereby preventing generation of noise.

The present disclosure has an effect of providing a hairdryer capable of improving stability and efficiency while reducing noise by appropriately adjusting the shape and length of each of existing components without addition of another component.

The present disclosure has an effect of providing a hairdryer capable of minimizing loss that may be generated at an impeller and a vane.

### DESCRIPTION OF DRAWINGS

FIG. 1 is a perspective view showing a hairdryer according to an embodiment of the present disclosure.

FIG. 2 is an interior sectional view of the hairdryer according to the embodiment of the present disclosure.

FIG. 3 is a sectional view of an air flow unit according to an embodiment of the present disclosure.

FIG. 4 is an exploded perspective view of the air flow unit according to the embodiment of the present disclosure.

FIG. 5 is a perspective view of an impeller according to an embodiment of the present disclosure.

FIG. 6 is a perspective view of a guide unit according to an embodiment of the present disclosure.

FIG. 7 is an exploded perspective view of the impeller and the guide unit according to the embodiment of the present disclosure.

FIG. 8 is a graph schematizing experimental data according to an embodiment of the present disclosure.

### BEST MODE FOR DISCLOSURE

Hereinafter, embodiments disclosed in this specification will be described in detail with reference to the accompanying drawings. In this specification, the same or similar elements are denoted by the same or similar reference numerals even in different embodiments, and the description is replaced by the first description. In this specification, singular forms are intended to include plural forms unless mentioned otherwise. Also, in describing the embodiments disclosed in this specification, a detailed description of known technology related thereto will be omitted when the same may obscure the subject matter of the embodiments disclosed in this specification. In addition, it should be noted that the accompanying drawings are provided merely to assist in easy understanding of the embodiments disclosed in this specification, and the accompanying drawings do not limit the technical idea disclosed in this specification.

Also, in this specification, the term “and/or” includes a combination of a plurality of stated items or any one of the plurality of stated items. In this specification, “A or B” may include A, B, or both A and B.

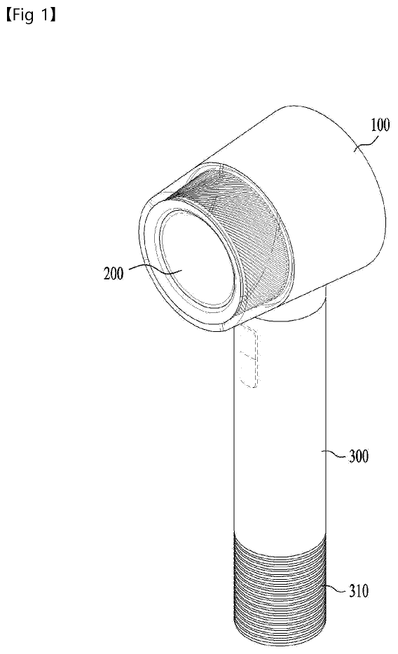

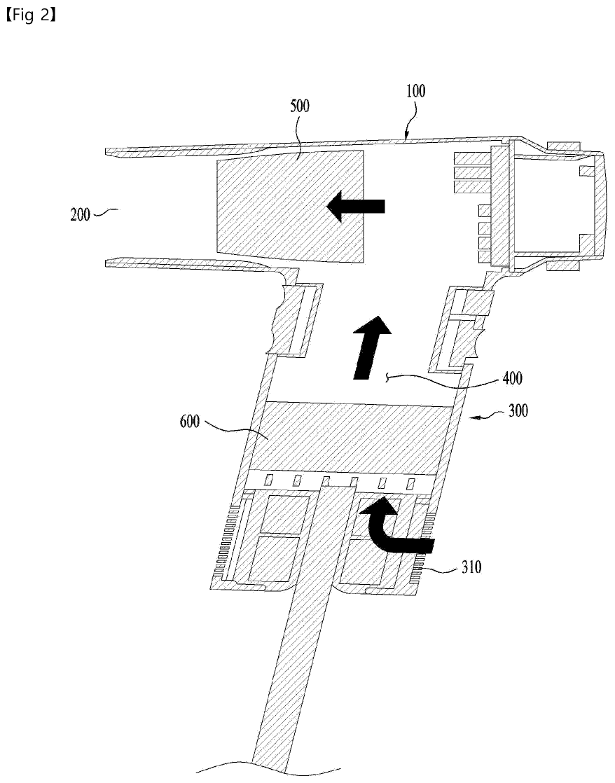

FIG. 1 is a perspective view of a hairdryer according to an embodiment of the present disclosure, and FIG. 2 is a sectional view showing the interior of the hairdryer according to the embodiment of the present disclosure. As shown in FIGS. 1 and 2, the hairdryer according to the embodiment of the present disclosure includes a main body 100 and a handle 300.

The main body 100 may have a cylindrical shape. However, the present disclosure is not limited thereto, and the main body may be formed so as to have any of various shapes. The main body 100 may be provided in one surface thereof with an outlet 200, through which air is discharged. Air that flows in the main body 100 is introduced through an inlet 310, and the inlet 310 may be provided in the main body 100 or the handle 300.

When the inlet 310 is provided in the handle 300, a flow channel, along which air flows, may be formed in the handle 300. In addition, the inlet 310 formed in the handle 300 may communicate with the outlet 200 formed in the main body 100.

The handle 300 may extend from one side of the main body 100. The handle 300 may extend from one surface of the main body 100 excluding the portion thereof in which the outlet 200 is formed.

In general, the handle may extend in a direction approximately perpendicular to the surface in which the outlet 200 is formed. For example, it is preferable for the handle 300 to be formed such that the outlet 200 of the main body 100 faces the direction in which finger knuckles are directed when a user holds the handle 300. However, the present disclosure is not limited thereto, and the handle 300 may extend from the surface that faces the outlet 200.

In FIGS. 1 and 2, the handle 300 extending downwards from the main body 100 is shown. The handle 300 may be a portion held by the user. Consequently, the handle may have a shape capable of improving grip convenience. The handle 300 may extend in various directions. Hereinafter, however, the direction in which the handle 300 extends from the main body 100 will be described as a downward direction for convenience of description.

The inlet 310, through which external air is introduced into the hairdryer, may be formed in a lower part of the handle 300. The inlet 310 may be formed in the lower part of the handle 300 so as to face an outer circumferential surface thereof. However, the present disclosure is not limited thereto, and the inlet may be variously formed. For example, the inlet may be formed toward a lower side of the handle 300. The inlet 310 may be formed so as to have a plurality of through-holes such that external air can be introduced through the through-holes.

In an embodiment of the present disclosure, the hairdryer may include an air flow unit 600 configured to suction external air such that air flow is generated in the hairdryer. The air flow unit 600 may be disposed in the main body 100 or the handle 300. In the present disclosure, the air flow unit 600 is described as being disposed in the handle 300.

A heater 500 capable of adjusting the temperature of air that is discharged to the outlet 200 according to the air flow generated by the air flow unit 600 may be provided in the main body 100.

In FIG. 2, the heater 500 provided in the main body 100 is schematically shown. The heater 500 may be configured to have a structure in which current is supplied to a coil type resistor to generate heat, whereby gas is heated. However, the present disclosure is not limited thereto, and a thermoelectric element may be used to heat gas.

The heater 500 may be disposed in the main body 100 at various positions. If the distance between the outlet 200 and the heater 500 is long, however, gas discharged through the outlet 200 is cooled before reaching the user, whereby the purpose of use may not be achieved. Consequently, it is preferable for the heater 500 to be disposed in the main body 100 so as to be adjacent to the outlet 200. However, the present disclosure is not limited thereto, and the heater may be disposed in other parts of the main body 100 as long as the temperature of the gas discharged from the outlet 200 is appropriately adjustable.

The operation of the hairdryer according to the embodiment of the present disclosure will be described briefly based on gas flow.

First, the user manipulates a power button disposed on the main body 100 or the handle 300. When the power button is turned on, the air flow unit 600 is operated, whereby external air is introduced into the hairdryer through the inlet 310.

Air introduced through the introduction port 310 flows along an inner space of the handle 300 by the air flow unit 600, is directed toward the outlet 200, is discharged through the outlet 200, and is provided to the user. The user may dry wet hair or may style the hair so as to have a specific shape using the discharged air. In addition, the air may also be used to tidy the hair.

During this process, the flow speed of the air in the handle 300 and the main body 100 may be adjusted by the air flow unit 600, and the temperature of the air may be adjusted by the heater 500. The operation state of the air flow unit 600 and the heater 500 may be adjusted by the user manipulating a manipulator or may be automatically adjusted according to an operation mode preset in a controller.

An embodiment of the present disclosure may include an operation mode capable of improving convenience in user manipulation or usability of the hairdryer. In addition, the manipulator may be provided such that the user selects a desired operation mode and uses the hairdryer, and the manipulator may be configured in various kinds and shapes.

For example, the manipulator may be constituted by a plurality of buttons or a rotary dial so as to select an operation mode, and an additional button or selection means may be further included.

In addition, the manipulator may be provided at the main body 100 or the handle 300 so as to be manipulated by the user, and a plurality of buttons or manipulation means may be disposed at the main body 100 or the handle 300 in a distributed state.

Meanwhile, the controller may be signally connected to a temperature sensor mounted in the hairdryer. The controller may be installed at various positions as needed, and the controller may be disposed in the main body 100 on a PCB installed adjacent to a rear surface thereof.

In addition, the controller may set the current operation mode through the manipulator manipulated by the user. The controller may receive a setting value manipulated by the user to control the driving state of the heater 500 and the air flow unit 600.

At this time, the heater 500 may be manipulated so as to have a temperature value set by the controller. For example, 28° C., 40° C., 60° C., and 90° C. may be prestored in the controller as first, second, third, and fourth temperatures, and the temperature of the heater 500 may be set to any one of the first, second, third, and fourth temperatures.

That is, the controller may be electrically and signally connected to the manipulator, the heater 500, and the air flow unit 600. The controller may receive a signal from the manipulator, and may control the heater 500 and the air flow unit 600 based on the temperature and speed of the discharged air.

The outlet provided in the main body 100 is shown. As shown in FIG. 1 or 2, the main body 100 may have an approximately circular section and a predetermined length. However, the sectional shape of the main body 100 may be various as needed.

Although the shape of the main body 100 may be various, the shape of the main body 100 having a circular section and a predetermined length is shown in FIGS. 1 and 2. Hereinafter, a description will be given based on the main body 100 configured such that the main body extends forwards and rearwards to have a predetermined length and has an approximately circular section, as shown in FIG. 1, for convenience of description.

Although one open side of the main body 100 may be formed at various positions, the open side may be formed at a front surface of the main body, as shown in FIG. 2, and the outlet 200 may be configured to cover a part of the open side while constituting the front surface of the main body 100, as shown in FIG. 2.

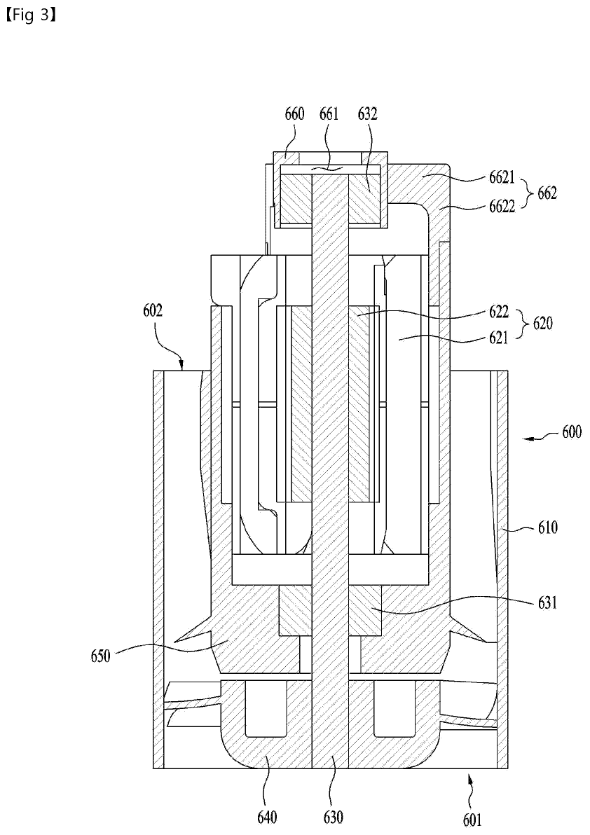

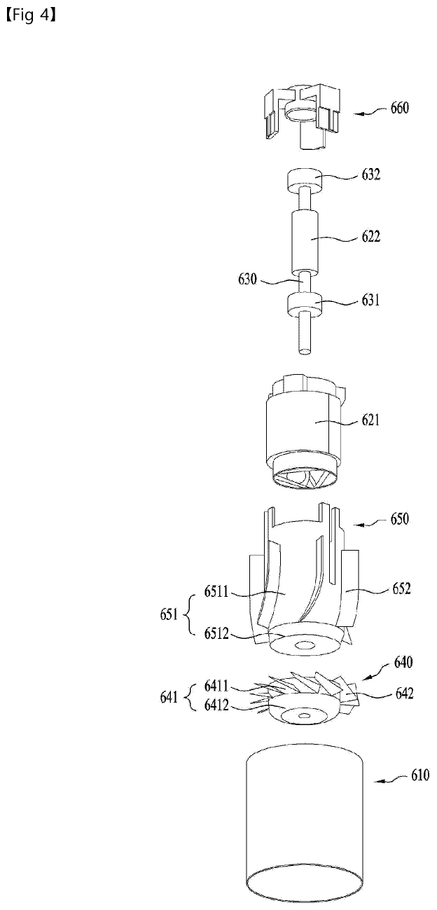

FIGS. 3 and 4 are a coupled sectional view and an exploded perspective view of the air flow unit, respectively.

Referring to FIG. 3, the air flow unit 600 may include a case 610 including a suction portion 601 configured to suction external air introduced through the inlet 310 and a discharge portion 602 configured to discharge the air out of the air flow unit 600 and to guide the air to the outlet 200 of the hairdryer. The case 610 defines the external shape of the air flow unit 600 and includes other components configured to generate air flow therein.

The case 610 may include a driving unit 620 including a stator 621 fixed in the case 610 to generate a rotating magnetic field and a rotor 622 received in the stator 621 so as to be rotated by the rotating magnetic field. In addition, a rotary shaft extending or coupled in a direction from the rotor 622 to the suction portion 601 or the discharge portion 602 may be included. The rotary shaft 630 may be rotated via rotation of the stator 621 and may transmit rotational force to a component coupled to one end of the rotary shaft 630. Here, the driving unit 620 and the rotary shaft 630 may be configured as a single module, and a generally used motor may be used.

An impeller 640 configured to generate air flow may be coupled to one end of the rotary shaft 630 in a direction toward the suction portion 601. The impeller 640 may be rotated via the rotary shaft 630 to generate air flow in which air is suctioned to the suction portion 601 and the suctioned air is discharged in a direction toward the discharge portion 602. The impeller 640 may have a through-hole formed in a central part thereof such that the rotary shaft 630 is forcibly fit into the through-hole, or may be coupled to the rotary shaft in another manner.

The impeller 640 may include a hub 641 coupled to the rotary shaft, the hub constituting a central part thereof, and a blade 642 configured to generate air flow when rotated. The hub 641 may have a cylindrical shape; however, the present disclosure is not limited thereto, and may have other shapes as long as the hub can be coupled to the rotary shaft 630.

The blade 642 may be formed on an outer circumferential surface of the hub 641 so as to protrude in a radial direction. Various numbers of blades 642 may be formed. It is preferable to provide a sufficient number of blades to generate air flow necessary to use the hairdryer.

In addition, the blade 642 may have various shapes. The blade 642 may be set such that the part of the blade connected to the hub 641 and a free end of the blade have different inclinations. The blade 642 may be configured to generate sufficient air flow while coupling stability of the blade is improved. It is preferable for the blade 642 to be formed such that the length of one end of the blade coupled to the hub 641 is shorter than the length of the free end of the blade. When the blade 642 is formed as described above, it is possible to generate stronger air flow. However, the present disclosure is not limited thereto, and the blade may have various shapes.

The hub 641 may include a hub body 6411, from which the blade 642 protrudes, and a hub cap 6412 extending from the hub body 6411 toward a side surface of the suction portion 601.

Here, extending is a meaning including extending while being integrally formed and coupling of a separate component. That is, the hub cap 6412 may extend from one surface of the hub body 6411 in a direction toward the suction portion 601 while being integrally formed with the hub body 6411, or may be formed as a component separated from the hub body 6411 and may be coupled to the hub body 6411 so as to cover one side of the hub body in the direction toward the suction portion 601.

Since the driving unit 620 and the impeller 640 are connected to the same rotary shaft 630, the hub cap 6412 may be installed at a front surface of the hub 641 of the impeller 640 in order to protect an internal structure of an axial fan. At the same time, the hub cap may function to reduce nonuniform inlet flow. In general, performance of the axial fan may be greatly changed by the hub cap 6412. Here, the axial fan is a fan that generates flow in a longitudinal direction of the rotary shaft.

The shape of the hub cap 6412 may function to adjust the flow of air suctioned through the suction portion 60, thereby improving efficiency and stability of the impeller 640 and solving a noise generation problem. The structure and effects of the hub cap 6412 will be described in detail below.

The case 610 may be provided therein with a guide unit 650 configured to guide air suctioned through the suction portion 601 of the case 610 by the impeller 640 in a direction toward the discharge portion 602 of the case 610. The circumferential speed of air introduced by the impeller 630 is high due to rotation of the impeller 640. In order to remove the circumferential speed and to increase the axial speed, therefore, the guide unit 650 may be included. Here, the axial speed is the speed in a direction from the suction portion 610 of the case 610 to the discharge portion 602.

The guide unit 650 may be coupled to an outer circumferential surface of the stator 621 constituting the driving unit 620 to guide air that flows in the case 610. However, the present disclosure is not limited thereto, and the guide unit may be fixed to an inner circumferential surface of the case 610 as long as it is possible to guide air flow. In addition, the guide unit 650 may receive the stator 621, the rotor 622, and the rotary shaft 630 to support the driving unit 620 in the case 610.

The guide unit 650 may include a guide hub 651 configured to form a main body at the center thereof and to define a space, in which the stator 621 is received, and a guide blade 652 protruding from an outer circumference of the guide hub 651 to guide air in the case 610 from the suction portion 601 to the discharge portion 602. A plurality of guide blades 652 may be provided. An appropriate number of guide blades may be provided so as not to disturb air flow while sufficiently guiding air in the case 610.

The guide blade 652 may be provided side by side in an axial direction of the rotary shaft 630. However, the present disclosure is not limited thereto, and the guide blade may be inclined from the axial direction of the rotary shaft 630 and may have curvature in an inclined direction. When the guide blade 652 is curved, it is possible to obtain an effect of smoothly guiding air flow, thereby stabilizing the flow.

The number of blades 642 may be greater than or equal to the number of guide blades 652. The blade 642 may perform a function to generate air flow, and the guide blade 652 may perform a function to guide the flow generated by the blade 642.

The blade 642 is directly rotated by the rotary shaft. When the number of the blades 642 is increased, therefore, it is possible to more effectively generate air flow. In contrast, the guide blade 652 is stationary, and when the number of guide blades 652 is excessively large, air flow may be disturbed.

When the number of blades 642 is greater than the number of guide blades 652, therefore, air flow may be more effectively generated, and the generated air flow may be efficiently guided.

The guide hub 651 may include a guide hub body 6511 forming a main body from which the guide blade 652 protrudes and a guide hub cap 6512 extending from the guide hub body 6511 in a direction toward the impeller 640. Here, extending may be coupling of a separate component or integral formation. The guide hub body 6511 and the guide hub cap 6512 may have various shapes to stabilize the flow of air that flows in the case 610. The shape and effects of the guide hub cap 6512 will be described below.

The construction and coupling relationship of the air flow unit 600 will be described with reference to FIG. 4. As previously described, the case 610 defining the external shape may be provided to receive other components. The driving unit 620 constituted by the stator 621 and the rotor 622 may be received in the case 610.

The case 610 may receive all of the stator 621, the rotor 622, and the guide unit 650. However, the present disclosure is not limited thereto, and the case may be provided to receive some thereof.

The rotary shaft 630 extending from the center of the rotor 622 in a direction toward the discharge portion 602 of the case 610 or the inlet 310 may be included. The guide unit 650 may be coupled to the outer circumferential surface of the stator 621. The impeller 640 may be coupled to one end of the rotary 630 in a direction toward the inlet 310. The other end of the rotary shaft 630 may be received in a bracket 660. The bracket 660 may be coupled to one side of the case 610. In addition, the guide unit 650 may be coupled to the case 610 to support the driving unit 620, the rotary shaft 630, and the impeller 640.

A main bearing 631 coupled to an outer circumferential surface of the rotary shaft 630 located between the impeller 640 and the driving unit 620 to rotatably support the rotary shaft 630 may be further included.

The main bearing 631 may be provided between the stator 621 and the guide unit 650 in contact with the stator 621 or the guide unit 650. The main bearing 631 may be supported by the stator 621 or the guide unit 650. In an embodiment of the present disclosure, the main bearing 631 may be provided so as to simultaneously contact one surface of the stator 621 that faces the impeller 640 and an inner circumferential surface of the guide unit 650.

An auxiliary bearing 632 configured to rotatably support the rotary shaft 630 may be coupled to one end of the rotary shaft 630 in the direction toward the discharge portion 602. The auxiliary bearing 632 may support a load applied to the rotary shaft together with the main bearing 631.

The auxiliary bearing 632 may be received in the bracket 660, which receives the auxiliary bearing 632, so as to be rotatable while being supported thereby. The bracket 660 may be coupled to the guide unit 650 or the case 610 so as to support a load applied by the rotary shaft 630.

The bracket 660 may include a receiving portion 661 having a receiving space, in which the rotary shaft 630 having the auxiliary bearing 632 coupled thereto is received, and a leg portion 662 protruding from an outer circumferential surface of the receiving portion 661 so as to be coupled to the guide unit 650 or the case 610.

The receiving portion 661 and the leg portion 662 may be integrally formed. However, the present disclosure is not limited thereto, and the receiving portion and the leg portion may be formed as separate components and may be coupled to each other via a coupling member.

In addition, the receiving space is defined in the receiving portion 661 so as to wrap an outer circumferential surface of the auxiliary bearing 632. A plurality of leg portions 662 may be provided, and various numbers of leg portions may be provided as long as it is possible to sufficiently support the auxiliary bearing 632.

The leg portion 662 may be constituted by two parts. The leg portion 662 may include a first leg 6621 protruding from the receiving portion in a radial direction of the receiving portion and a second leg 6622 protruding from a free end of the first leg 6621 toward the guide unit 650. The second leg 6622 may be coupled to the guide unit 650 or the case 610 to support the rotary shaft 630 and the auxiliary bearing 632.

A receiving recess may be formed in one side of the guide hub 651. This may be formed so as to be engaged with a protrusion protruding from the outer circumferential surface of the stator 621. In addition, a coupling portion protruding from one side of the second leg 622 constituting the bracket 660 so as to be engaged with the receiving recess of the guide hub 651 may be included. Therethrough, the stator 621, the rotor 622, and the rotary shaft 630 may be fixed in a receiving space defined by the guide unit 650 and the bracket 660.

As described above, the guide unit 650 may be provided to receive other components; however, the present disclosure is not limited thereto. The guide unit 650 may be integrally formed with the case 610. The driving unit 620 may be provided between the guide unit 650 and the discharge portion 602. The impeller 640 may also be provided so as to be coupled to the rotary shaft 630 between the guide unit 650 and the driving unit 620.

When the guide unit 650 is provided to receive the driving unit 620, as shown in FIG. 4, other components, such as the driving unit 620 and the rotary shaft 630, may be disposed in a space occupied by the guide unit 650, whereby space efficiency is improved.

In addition, when the guide unit 650 receives the driving unit 620 and is supported by the main bearing 631, the auxiliary bearing 632, and the bracket 660, it is possible to attenuate a part of vibration generated by the driving unit 620. Vibration generated as the result of operation of the driving 620 is one of main causes that generate noise when the hairdryer is operated.

Vibration of the driving unit 620 may be attenuated by the guide unit 650, the main bearing 631, the auxiliary bearing 632, and the bracket 660, whereby it is possible to prevent the user from feeling inconvenience or discomfort due to unnecessary noise during use of the hairdryer.

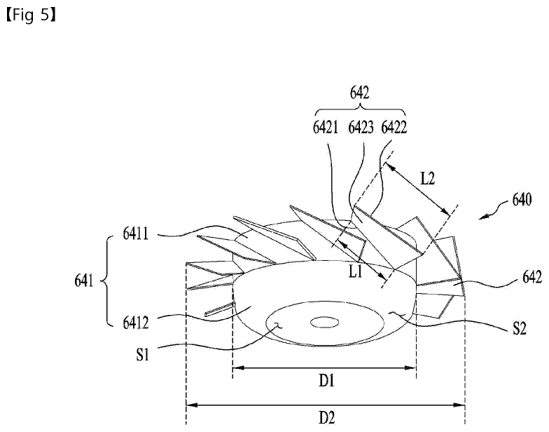

FIG. 5 is a perspective view of an impeller according to an embodiment of the present disclosure.

Referring to FIG. 5, the impeller 640 may include a hub 641 coupled to the rotary shaft, the hub having a through-hole, and a blade 642 protruding from the hub 641 in the radial direction of the impeller 640 to generate air flow when the impeller 640 is rotated, as previously described.

The hub 641 may include a hub body 6411 forming a body and having an outer circumferential surface from which the blade 642 protrudes and a hub cap 6412 extending from the hub body 6411 in the direction toward the inlet 310. Here, extending is a concept including extending while being integrally formed and coupling of a separate component, as previously described.

The blade 642 may include a first fixing portion 6421 corresponding to the part that contacts the hub 641, a first free portion 6422 disposed adjacent to the inner circumferential surface of the case 610, the first free portion forming a free end of the blade 642, and a first body portion 6423 configured to connect the first fixing portion 6421 and the first free portion 6422 to each other.

The first fixing portion 6421, which is the part of the outer circumferential surface of the hub 641 that contacts the blade 642, may be curved. In addition, the first free portion 6422 may be a part of the blade 642 disposed adjacent to the case 610. The first free portion 6422 may be a curved line of a distal end of the blade 642. However, the present disclosure is not limited thereto, and the first free portion may be a curved surface forming the free end of the blade 642.

When the first fixing portion 6421 is a curved surface of the outer circumferential surface of the hub 641 that contacts the blade 642, the straight distance of the curved surface forming the first fixing portion 6421 between axial opposite ends of the rotary shaft 630 may be defined as a first chord length L1.

In general, the chord length means the straight distance between the point at which a fluid first contacts a specific object and the point at which the fluid last contacts the object when the fluid flows along the object.

In the present disclosure, the straight distance between the point at which air first contacts the blade 642 and the point at which the air last contacts the blade 642 when the air flows in the axial direction of the rotary shaft 630 may be defined as a chord length.

The first chord length L1 or the circumferential length of the hub body 6411 may be adjusted such that the first chord length L1 is greater than 1.4 times a first circumferential length, which is the value obtained by dividing the circumferential length of the hub body 6411 by the number of blades 642, and is less than 1.5 times the first circumferential length.

As described above, the first circumferential length may mean the average circumferential length of the hub body 6411 occupied by one of the plurality of blades 642. That is, a C/S value, which is the value obtained by dividing the first chord length L1 by the first circumferential length, may mean the ratio of the chord length to a circumferential space occupied by one blade 642 having the chord length.

Here, the first circumferential length may be expressed by π*D1/N, where N indicates the number of blades 642.

When describing the C/S value again, C, which is the first letter of “chord”, means the chord length, which is denoted by reference symbol L in the drawings.

The value of S, which is the first letter of “space”, means the value obtained by dividing the circumferential length by the number N of blades 642. The circumferential length means the value obtained by multiplying the diameter denoted by D in the drawings by the ratio of the circumference of a circle to its diameter 7E. That is, when expressed using a mathematical expression, S=π*D/N.

Eventually, the C/S value may be expressed as follows using reference numerals in the drawings.

C/S=(L*N)/(π*D)

Hereinafter, embodiments of the present disclosure will be described using lengths D and L shown in the drawings and N, which means the number of blades.

In addition, the above ratio may be applied to the first free portion 6422. A second chord length L2, which is the straight distance of the first free portion 6422 between one end and the other end of the rotary shaft 630 in the axial direction, may be configured to be greater than 1.4 times a second circumferential length, which is the value obtained by dividing the circumferential length of a circle having a diameter equal to the diameter D2 of the impeller 640 by the number of blades 642, and to be less than 1.5 times the second circumferential length.

Here, the second circumferential length may be expressed by π*D2/N, where N indicates the number of blades 642.

The diameter equal to the diameter D2 of the impeller 640 may mean the diameter equal to the maximum diameter D2 of the impeller 640. That is, the diameter may mean the maximum length in the radial direction including the blade 642.

When the C/S value has a value of 1.4 to 1.5 with respect to the impeller 640, as described above, flow efficiency of air that flows to the impeller 640 may be highest and noise may be reduced.

The hub cap 6412 may be formed such that the sectional area of the hub cap is gradually reduced from the hub body 6411 to the inlet 310. Here, the section means the section perpendicular to the axial direction of the rotary shaft 630.

When the sectional area uniformly extends, the flow of air suctioned through the suction portion 601 of the case 610 as the impeller 640 is rotated may generate vortex while passing through the hub 641. If the air is introduced to the blade 642 in the state in which the vortex is generated, a three-dimensional flow may be formed, whereby flow loss may occur and efficiency of the impeller may be reduced. In addition, if the three-dimensional flow occurs, undesired noise may be generated, whereby the user may experience discomfort.

When the section of the hub cap 6412 is configured to be gradually increased in an air flow direction, however, air may naturally flow along the surface thereof during rotation of the impeller 640, whereby it is possible to somewhat prevent flow loss.

The hub cap 6412 may include a first surface S1 having a circular shape forming a free end and a second surface S2 extending from the first surface S1 toward the hub body 6411 to form a side surface of the hub cap 6412.

The second surface S2 may be formed so as to have an inclination gradually increased from the first surface S1 to the hub body 6411. That is, the hub cap 6412 may be configured to have a trapezoidal section having a side surface formed as a convex line, not a trapezoidal section in a direction parallel to the axial direction of the rotary shaft 630.

The second surface S2 may be formed convex in an extension direction of the hub cap 6412. In 3D modeling, curved connection between two parallel sections may be expressed as “blend processing” or “blend provision”. That is, a blend may be provided to the hub cap 6412 to stabilize the flow of air introduced through the suction portion 601.

When the second surface S2 is curved, whereby introduced flow is stabilized, flow loss may be prevented, whereby it is possible to improve efficiency and stability of the impeller 640. In addition, the occurrence of vortex in the flow may be prevented, whereby it is possible to reduce noise generated by the vortex.

The first surface S1 may be disposed on the same line as one end of the case 610 in which the inlet 310 is formed. Conventionally, the hub cap 6412 is not curved, unlike the present disclosure, and therefore the hub cap 6412 extends so as to protrude out of the case 610 in order to reduce flow loss. When the second surface S2 is curved, as in the present disclosure, however, it is not necessary to extend the hub cap 6412, and therefore the hub cap may be located at the same height as one end of the case 610.

When the hub cap 6412 is manufactured, as described above, the weight of the impeller 640 may be reduced. Consequently, it may be not necessary to form a recess in the impeller 640, unlike a conventional product in which a recess is formed in the impeller 640 in order to reduce the weight of the impeller 640.

If a recess is formed in the impeller 640, as the conventional product, rapidly introduced air is introduced into the recess, whereby turbulence and vortex are formed in the recess, and therefore unexpected noise may be generated.

When the second surface S2 of the impeller 640 is curved, as in the present disclosure, however, the hub cap 6412 may be made so as to be smaller, and therefore it is not necessary to form a recess in one surface of the impeller 640 in a direction toward the driving unit 620 in order to reduce the weight of the impeller 640. Consequently, it is possible to solve a noise problem that occurs in the impeller 640 of the conventional product.

When a recess for weight reduction is not formed in the impeller 640, as described above, the axial distance between one surface of the hub body 6411 that faces the guide unit 650 and the guide unit 650 may be uniform.

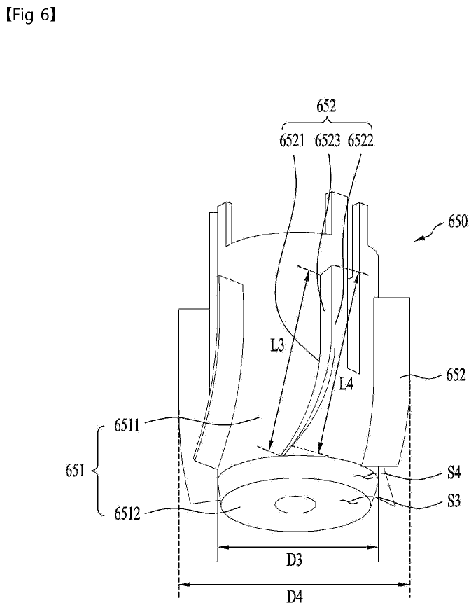

FIG. 6 is a perspective view of a guide unit according to an embodiment of the present disclosure.

Referring to FIG. 6, the guide unit 650 may include a guide hub 651 having a receiving space defined therein and a guide blade 652 protruding from the guide hub 651 in a radial direction.

The guide hub 651 may receive the driving unit 620 and the rotary shaft 630 therein. In addition, the guide blade 652 protruding from an outer circumferential surface of the guide hub 651 may function to guide air introduced by the impeller 640 so as to be discharged toward the discharge portion 602.

A plurality of guide blades 652 may be provided. The guide blade 652 may protrude from the guide hub 651 so as to be parallel to the axial direction of the rotary shaft 630. In order to smoothly guide air flow, however, the guide blade 652 may be configured to have a predetermined inclination relative to the axial direction. When the guide blade 652 is inclined, it is possible to somewhat prevent formation of turbulence on the surface thereof.

The guide hub 651 may include a guide hub body 6511 from which the guide blade 652 protrudes and a guide hub cap 6512 extending from one surface of the guide hub body 6511 adjacent to the impeller 640 in the direction toward the impeller 640. Here, extending is a concept including both extending while being integrally formed and coupling of a separate component in contact.

As described above for the impeller 640, the C/S value may also be appropriately adjusted for the guide unit 650.

The guide blade 652 may include a second fixing portion 6521 corresponding to the part that contacts the guide hub 651, a second free portion 6522 disposed adjacent to the inner circumferential surface of the case 610, the second free portion forming a free end of the guide blade 652, and a second body portion 6523 configured to connect the second fixing portion 6521 and the second free portion 6522 to each other.

The second fixing portion 6521, which is the part of the outer circumferential surface of the guide hub 651 that contacts the guide blade 652, may be curved. In addition, the second free portion 6522 may be a part of the guide blade 652 disposed adjacent to the case 610. The second free portion 6522 may be a curved line of a distal end of the guide blade 652. However, the present disclosure is not limited thereto, and the second free portion may be a curved surface forming the free end of the guide blade 652.

When the second fixing portion 6521 is a curved surface of the outer circumferential surface of the guide hub 651 that contacts the guide blade 652, the straight distance of the curved surface forming the second fixing portion 6521 between axial opposite ends of the rotary shaft 630 may be defined as a third chord length.

In general, the chord length means the straight distance between the point at which a fluid first contacts a specific object and the point at which the fluid last contacts the object when the fluid flows along the object.

In the present disclosure, the straight distance between the point at which air first contacts the guide blade 652 and the point at which the air last contacts the guide blade 652 when the air flows in the axial direction of the rotary shaft 630 may be defined as a chord length.

The third chord length L3 or the circumferential length of the guide hub body 6511 may be adjusted such that the third chord length L3 is greater than 1.5 times a third circumferential length, which is the value obtained by dividing the circumferential length of the guide hub body 6511 by the number of guide blades 652, and is less than 2 times the third circumferential length.

As described above, the third circumferential length may mean the average circumferential length of the guide hub body 6511 occupied by one of the plurality of guide blades 652. That is, a C/S value, which is the value obtained by dividing the third chord length L3 by the third circumferential length, may mean the ratio of the chord length to a circumferential space occupied by one guide blade 652 having the chord length. The third circumferential length is expressed by π*D3/N, where N indicates the number of guide blades 652.

In addition, the above ratio may be applied to the second free portion 6522. A fourth chord length L3, which is the straight distance of the second free portion 6522 between one end and the other end of the rotary shaft 630 in the axial direction, may be configured to be greater than 1.5 times a fourth circumferential length, which is the value obtained by dividing the circumferential length of a circle having a diameter equal to the diameter of the guide unit 650 by the number of guide blades 652, and to be less than 2 times the fourth circumferential length.

Here, the fourth circumferential length may be expressed by π*D4/N, where N indicates the number of guide blades 652.

The diameter equal to the diameter of the guide unit 650 may mean the diameter equal to the maximum diameter of the guide unit 650. That is, the diameter may mean the maximum length in the radial direction including the guide blade 652.

When the C/S value has a value of 1.5 to 2.0 with respect to the guide unit 650, as described above, flow efficiency of air that flows to the impeller 640 may be highest and noise may be reduced.

In addition, the third chord length L3 may be greater than or equal to the first chord length L1. The first chord length L1 corresponds to the length related to the blade 642 that directly generates air flow, and the third chord length L3 corresponds to the length related to the guide blade 652 that guides air.

When the guide blade 652 is longer than the blade 642, air flow generated by the blade 642 may be more effectively guided toward the discharge portion. In addition, since excessive load is applied to the rotary shaft 630 that rotates the blade 642 when the blade 642 is excessively large, the length of the blade 642 may be adjusted to reduce load applied to the rotary shaft 630.

That is, when the third chord length L3 is greater than or equal to the first chord length L1, it is possible to improve air flow efficiency of the air flow unit and to prevent damage to the rotary shaft 630.

In addition, the third circumferential length may be greater than or equal to the first circumferential length. The number of blades 642 may be greater than the number of guide blades 652, whereas the circumferential length of the hub 641 may be less than the circumferential length of the guide hub 651.

Consequently, the third circumferential length, which is the value obtained by dividing the circumferential length of the guide hub 651 by the number of guide blades 652, may be greater than or equal to the first circumferential length, which is the value obtained by dividing the circumferential length of the hub 641 by the number of blades 642.

The guide hub cap 6512 may include a third surface S3 that faces the impeller and a fourth surface S4 extending from an outer circumferential surface of the third surface S3 toward the guide hub body 6511.

The third surface S3 may be formed so as to have an area less than the sectional area of the guide hub body 6511. That is, the sectional area of the guide hub cap 6512 may be gradually increased from the third surface to the guide hub body 651. Here, the sectional area may mean the area of the section in a direction perpendicular to the axial direction of the rotary shaft 630.

The fourth surface S4 may be curved. That is, the fourth surface S4 may be configured to have an inclination gradually increased from the third surface S3 to the guide hub body 6511. In other words, the fourth surface S4 may be formed convex toward the impeller 640.

When the fourth surface S4 is formed as described above, it is possible to prevent generation of turbulence and vortex in the flow of air suctioned by the impeller 640, passing through the blade 642, and flowing along the fourth surface S4. As described above, it is possible to reduce flow loss, and therefore it is possible to improve efficiency and stability of the air flow unit 600. In addition, it is possible to reduce noise generated by the flow loss.

The third surface S3 forming a free end of the guide hub cap 6512 may have a diameter greater than or equal to the diameter of the hub body 6411. When the diameter of the third surface S3 is less than the diameter of the hub body 6411, the flow channel of air that is introduced into the case 610 through the impeller 640 and flows extends while passing through the third surface S3.

When air passes through the abruptly extended flow channel, as described above, turbulence is formed in that portion. As a result, flow loss may be greatly generated by the turbulence during the flow of air. Consequently, the sectional area of the third surface S3 may be adjusted to gently form the flow channel along which the air flows.

When the diameter of the third surface S3 is equal to the diameter of the hub body 6411, air introduced into the case 610 through the impeller 640 flows along the gently extending flow channel, whereby it is possible to minimize flow loss and to reduce noise generated by turbulence.

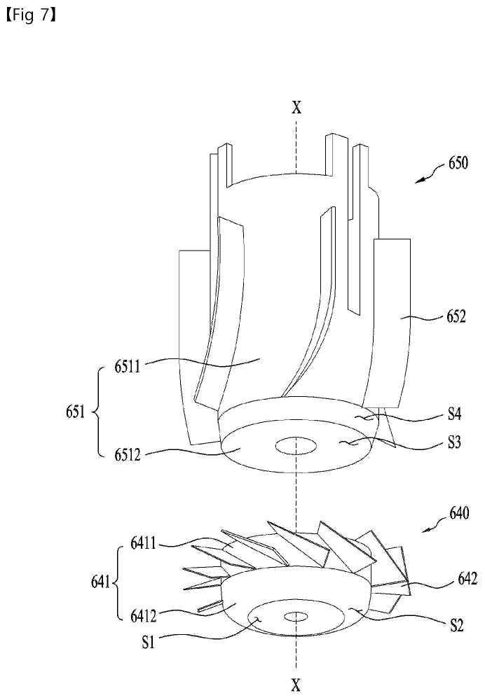

FIG. 7 shows the impeller and the guide unit.

Referring to FIG. 7, each of the blade 642 constituting the impeller 640 and the guide blade 652 constituting the guide unit 650 may be formed parallel to the axial direction (X-X) of the rotary shaft 630.

However, it is more preferable for each of the blade and the guide blade to be formed inclined relative to the axial direction (X-X) of the rotary shaft 630 than being formed parallel to the axial direction (X-X) of the rotary shaft 630, in terms of reducing flow loss.

First, the blade 642 constituting the impeller 640 is required to be formed inclined relative to the axial direction (X-X) of the rotary shaft 630 in order to suction external air according to rotation of the blade 642. If the blade 642 of the impeller 640 is provided parallel to the axial direction (X-X) of the rotary shaft 630, it may be difficult to generate air flow according to the rotation thereof.

Next, the guide blade 652 constituting the guide unit 650 guides air flow generated by the blade 642 of the impeller 640 toward the discharge portion 602. That is, it is not essential for the guide blade 652 to be provided inclined relative to the axial direction (X-X) of the rotary shaft 630.

However, it is preferable for the guide blade 652 constituting the guide unit 650 to be provided inclined relative to a direction opposite the direction in which the blade 642 constituting the impeller 640 is inclined relative to the axial direction (X-X) of the rotary shaft 630.

Turbulence and vortex may be generated in the flow of air passing through the impeller 640 in an inclination direction of the blade 642 by the inclination of the blade 642 of the impeller 640. When air flows along the guide blade 652 of the guide unit 650 inclined in the same direction as the blade 642 in this situation, intensities of the turbulence and the vortex may be further increased, whereby side effects, such as increase in flow loss and noise generation, may occur.

When the guide blade 652 of the guide unit 650 is inclined in a direction opposite the blade 642 of the impeller 640, however, turbulence and vortex generated while air passes through the blade 642 of the impeller 640 may be somewhat reduced while the air flows along the inclination in the opposite direction.

Consequently, it is possible to reduce flow loss generated by the turbulence or the vortex, whereby it is possible to improve efficiency and stability of the hairdryer. In addition, it is possible to reduce noise generated by the turbulence or the vortex.

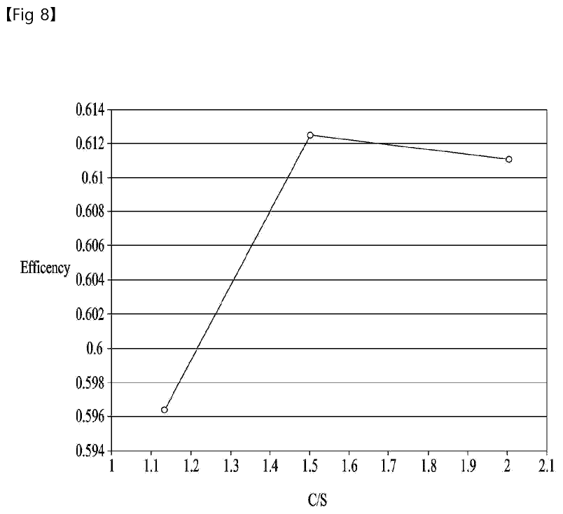

FIG. 8 is a graph showing data values obtained by experimenting on flow efficiency of the blade while adjusting the C/S value of the impeller.

The graph shows that, when the C/S value is about 1.5, the maximum efficiency is achieved. It can be seen that, if the C/S value is less than 1.5, efficiency increases as the C/S value increases. However, it can be seen that, if the C/S value exceeds 1.5, efficiency decreases as the C/S value increases. That is, since the local maximum value is obtained at about 1.5, it is preferable to appropriately adjust the size of the impeller 640 such that the C/S value approximates to 1.5.

For example, when the number of blades of the impeller 640 is 13, the C/S value approximates to 1.5 when the first chord length L1, which is the chord length of the first fixing portion 6421, is 6.3 mm and the diameter of the hub body 641 □ 1 is 17.5 mm, and therefore the impeller 640 may generate the maximum flow efficiency.

The present disclosure may be modified in various forms, and the scope of rights of the present disclosure is not limited to the above embodiments. When modifications include elements in the claims of the present disclosure, therefore, the modifications fall within the scope of rights of the present disclosure.

What is claimed is:

1. A hairdryer comprising:
a main body provided in one side thereof with an outlet configured to allow air to be discharged therethrough;
a handle extending from one side of the main body, the handle comprising an inlet communicating with the outlet, the inlet is configured to allow external air to be introduced therethrough;
a heater provided in the main body, the heater is configured to heat the air introduced through the inlet; and
an air flow unit disposed in one of the main body and the handle, the air flow unit being configured to move the air introduced through the inlet toward the outlet, wherein
the air flow unit comprises:
a case defining an external shape thereof, the case having a suction portion provided at one side thereof and a discharge portion provided at the other side thereof;
a driving unit comprising a stator fixed in the case, the stator is configured to generate a rotating magnetic field, and a rotor received in the stator so as to be rotated by the rotating magnetic field;
a rotary shaft extending from the rotor toward the suction portion or the discharge portion or coupled to the rotor; and
an impeller coupled to one end of the rotary shaft adjacent to the suction portion, the impeller is configured to suction air in an atmosphere while being rotated together with the rotary shaft,
the impeller comprises:
a hub coupled to the rotary shaft; and
at least one blade protruding from the hub toward an inner circumferential surface of the case, the blade is configured to generate air flow as the rotary shaft is rotated,
the blade comprises a first fixing portion disposed in contact with the hub, a first free portion disposed adjacent to the case, the first free portion is configured to form a free end, and a first body portion configured to connect the first fixing portion and the first free portion to each other, and
a first chord length, which is a straight distance of the first fixing portion between one end and the other end of the rotary shaft in an axial direction, is greater than 1.4 times a first circumferential length, which is a value obtained by dividing a circumferential length of the hub by the number of the blades, and is less than 1.5 times the first circumferential length.

2. The hairdryer of claim 1, wherein a second chord length, which is a straight distance of the first free portion between the one end and the other end of the rotary shaft in the axial direction, is greater than 1.4 times a second circumferential length, which is a value obtained by dividing a circumferential length of a circle having a diameter equal to a diameter of the impeller by the number of the blades, and is less than 1.5 times the second circumferential length.

3. The hairdryer of claim 1, further comprising a guide unit coupled to an outer circumferential surface of the stator, the guide unit being configured to guide air suctioned by the impeller toward the discharge portion.

4. The hairdryer of claim 3, wherein the guide unit comprises:
a guide hub coupled to the stator; and
at least one guide blade protruding from the guide hub toward the inner circumferential surface of the case, the guide blade being configured to guide the air suctioned by the impeller to the discharge portion.

5. The hairdryer of claim 4, wherein the number of the blades is greater than or equal to the number of the guide blades.

6. The hairdryer of claim 4, wherein
the guide blade comprises a second fixing portion disposed in contact with the guide hub, a second free portion disposed adjacent to the case, the second free portion being configured to form a free end, and a second body portion configured to connect the second fixing portion and the second free portion to each other, and
a third chord length, which is a straight distance of the second fixing portion between the one end and the other end of the rotary shaft in the axial direction, is greater than 1.5 times a third circumferential length, which is a value obtained by dividing a circumferential length of the guide hub by the number of the guide blades, and is less than 2 times the third circumferential length.

7. The hairdryer of claim 6, wherein the third chord length is greater than or equal to the first chord length.

8. The hairdryer of claim 6, wherein the third circumferential length is greater than or equal to the first circumferential length.

9. The hairdryer of claim 6, wherein a fourth chord length, which is a straight distance of the second free portion between the one end and the other end of the rotary shaft in the axial direction, is greater than 1.5 times a fourth circumferential length, which is a value obtained by dividing a circumferential length of a circle having a diameter equal to a diameter of the guide unit by the number of the guide blades, and is less than 2 times the fourth circumferential length.

10. The hairdryer of claim 4, wherein a diameter of the guide hub is greater than or equal to a diameter of the hub.

11. The hairdryer of claim 4, wherein the blade is inclined relative to the axial direction of the rotary shaft, and the guide blade is inclined in a direction opposite a direction in which the blade is inclined relative to the axial direction of the rotary shaft.

12. The hairdryer of claim 1, wherein
the hub comprises:
a hub body from which the blade protrudes; and
a hub cap extending from one surface of the hub body adjacent to the suction portion toward the suction portion, and
the hub cap has a sectional area decreased in an extension direction thereof.

13. The hairdryer of claim 12, wherein
the hub cap comprises a first surface configured to form a free end and a second surface configured to connect the first surface and the hub body to each other, and
a diameter of the first surface is less than a diameter of the hub body.

14. The hairdryer of claim 13, wherein the second surface is formed convex toward the suction portion.

15. The hairdryer of claim 13, wherein the first surface is disposed in the case.

16. The hairdryer of claim 4, wherein the guide hub comprises:
a guide hub body from which the guide blade protrudes; and
a guide hub cap extending from one surface of the guide hub body adjacent to the impeller toward the impeller, and
the guide hub cap has a sectional area decreased in an extension direction thereof.

17. The hairdryer of claim 16, wherein
the guide hub cap comprises a third surface configured to form a free end and a fourth surface configured to connect the third surface and the guide hub body to each other, and
a diameter of the third surface is less than a diameter of the guide hub body.

18. The hairdryer of claim 17, wherein the diameter of the third surface is greater than or equal to a diameter of the hub.

19. The hairdryer of claim 16, wherein a diameter of the guide hub is greater than or equal to a diameter of the hub.

20. The hairdryer of claim 1, wherein the air flow unit is provided in the handle and is located between the inlet and the main body.
